(19) United States
(12) Patent Application Publication
(10) Pub. No.: US 2019/0264470 A1
(43) Pub. Date: Aug. 29, 2019

(54) MOTORCYCLE BACKREST LOCKING DEVICE

(71) Applicant: Ralph William Dixon, Chesterfield, MI (US)

(72) Inventor: Ralph William Dixon, Chesterfield, MI (US)

(21) Appl. No.: 15/903,484

(22) Filed: Feb. 23, 2018

(51) Int. Cl. E05B 73/00; B62J 1/28; F16M 13/02

(52) U.S. Cl. CPC E05B 73/00; F16M 2200/025; F16M 13/02; B62J 1/28

(57) ABSTRACT

A system including a sheath implement a sheath implement that is configured to engage with a lock bracket implement. A sheath implement guide includes a plurality of angled wall portions, a header portion and a first lock cam slot portion. The lock bracket implement includes a guide block section having a plurality of angled edge portions that are configured to engage the plurality of angled wall portions of the sheath implement guide. A top ledge portion of the guide block section is configured to engage the header portion, and wherein the top ledge portion and header portion act as a stopper when the top ledge portion and the header portion makes contact. A second lock cam slot portion is configured to align with the first lock cam slot portion to accept a lock mechanism.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to vehicle accessories. More particularly, certain embodiments of the invention relate to a locking system that may secure a backrest in place on a motorcycle.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Different types of motorcycle accessories can be attached to and detached from a motorcycle for the purpose of changing the “functionality” or “look” of a motorcycle. For example, a backrest may be attached to the motorcycle for the comfort of a passenger or motorcycle rider. In other examples, a saddlebag, a luggage rack, and/or a travel trunk may be attached to a motorcycle to be used to transport groceries, luggage, camping gear, or other cargo. Traditionally, one of the most common ways to attach motorcycle accessories to a motorcycle were to bolt, screw, or otherwise permanently attach the accessories to various attachment points on the motorcycle. FIG. 1 is a diagrammatic front view of an exemplary backrest 100 that may be attached to a motorcycle, in accordance with the prior art. This exemplary backrest may comprise a backrest portion 101 and struts 105. Each strut 105 may comprise an anchor pin 110 at the end opposite backrest portion 101. In addition, struts 105 may be connected to each other by a spring 115 that may place pressure on struts 105 to typically push anchor pins 110 away from each other. Anchor pins 110 and spring 115 may be attached to struts 105 at connection points 120 using a variety of means such as, but not limited to, welding. FIG. 2 is a perspective rear view of an exemplary backrest mount 200 that may be used to attach a backrest to a motorcycle, in accordance with the prior art. This exemplary backrest mount 200 may comprise a curved base plate 201, a front frame mount bracket 205, and two fender mount brackets 210. Front frame mount bracket 205 and fender mount brackets 210 may allow for the mount to be attached to a motorcycle. A top opening 215 may enable anchor pins 110 and portions of struts 105 of the backrest to be inserted into the mount. One or more anchor holes 220 may be provided on each side of the mount into which the outer portions of anchor pins 110 may engage. The mount may be attached to a motorcycle frame in a position under or within a seat of the motorcycle. In many applications, the mount may be accessed through a narrow, slotted opening in the seat. To engage the backrest with the mount, a user typically compresses struts 105 toward each other giving anchor pins 110 clearance to be placed thru opening 215. When struts 105 are released, spring 115 may expand so that anchor pins 110 may engage with anchor holes 220. The inclusion of multiple anchor holes 220 may enable the backrest to be adjusted to different heights.

By way of educational background, an aspect of the prior art generally useful to be aware of is that due to the relative ease in which such backrests may be installed and removed from a motorcycle, it is believed that these backrests may be susceptible to accidental disengagement. Furthermore, one may expect that failure to effectively secure a backrest to a motorcycle may result in theft of the backrest.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic front view of an exemplary backrest that may be attached to a motorcycle, in accordance with the prior art;

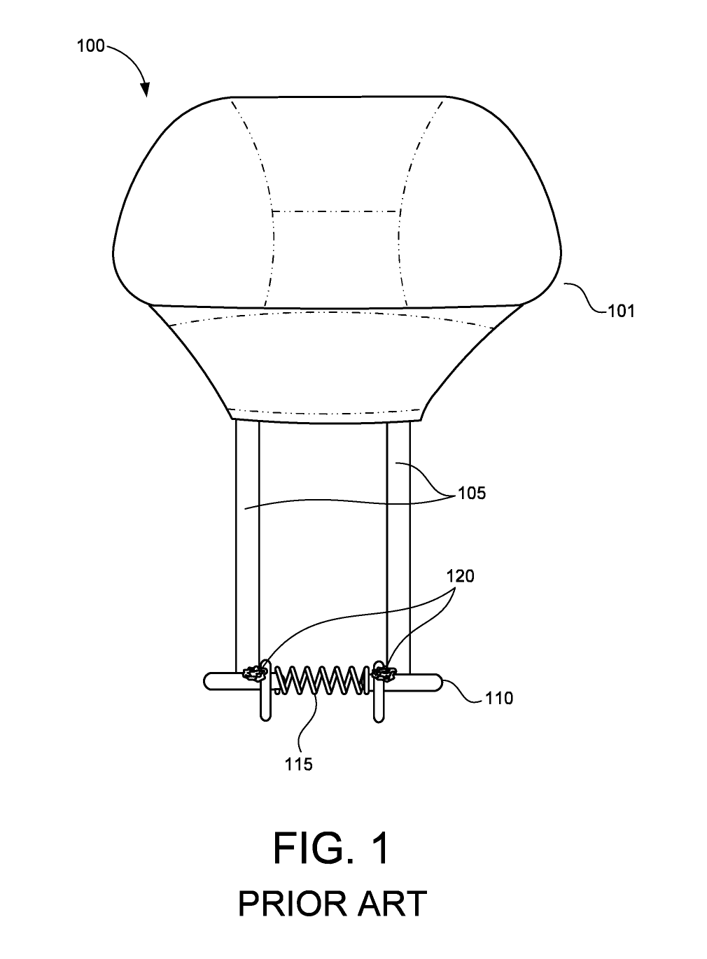

FIG. 2 is a perspective rear view of an exemplary backrest mount that may be used to attach a backrest to a motorcycle, in accordance with the prior art;

FIG. 3 is a perspective rear view of an exemplary sheath implement for a locking system that may secure a backrest in place on a motorcycle, in accordance with an embodiment of the present invention;

FIG. 4 is an exploded side view of an exemplary lock mechanism that may be incorporated into a sheath from a motorcycle backrest locking system, in accordance with an embodiment of the present invention;

FIG. 5 is a perspective side view of a lock bracket for a locking system that may secure a backrest in place on a motorcycle, in accordance with an embodiment of the present invention;

FIG. 6 is a perspective rear view of an exemplary backrest mount modified for use with a locking system that may secure a backrest in place on a motorcycle, in accordance with an embodiment of the present invention; and

FIG. 7 is a diagrammatic front view of an exemplary sheath in a locked position on a motorcycle backrest, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a locking system that may secure a motorcycle backrest in place on a motorcycle. Some embodiments may comprise a sheath and a lock bracket made of various metals with or without an anodized finish, such as, but not limited to, aluminum, stainless steel, brass, or hardened steel. Alternate embodiments may be made of various plastics, composite materials, or a combination of materials. The lock bracket may be in engagement with a mount for a motorcycle backrest, and the sheath may slide over a spring portion of the backrest when the backrest is installed in the mount. The sheath may further comprise a lock that may engage with a portion of the lock bracket to typically lock the sheath in place in the mount. In some applications such embodiments may be used to protect a motorcycle backrest from theft.

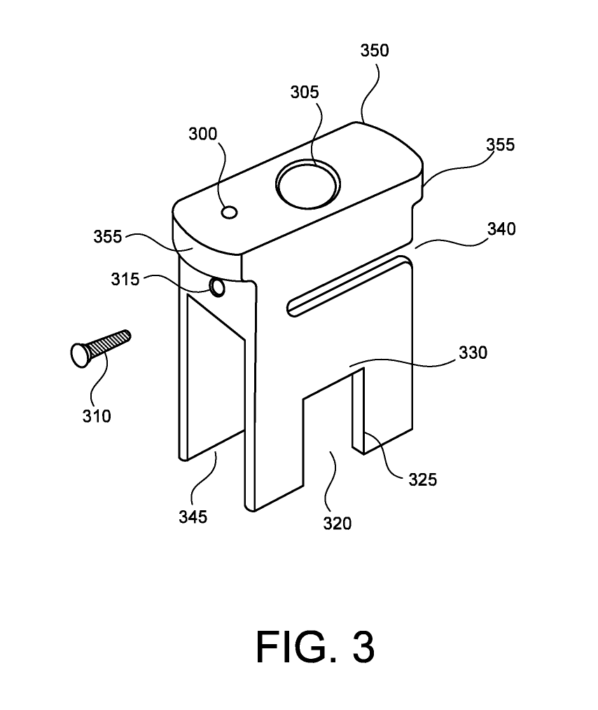

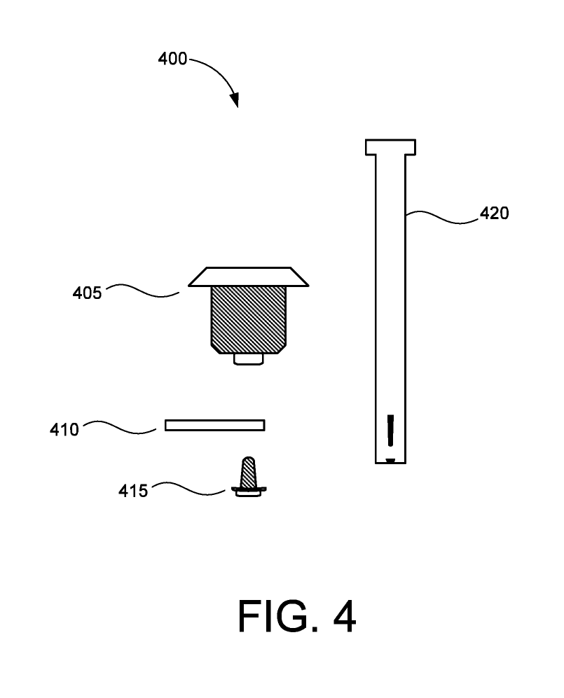

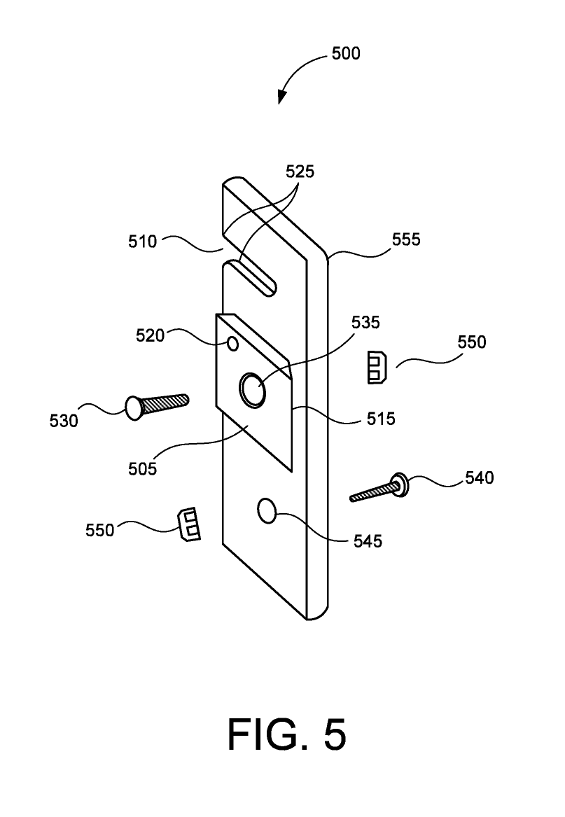

FIG. 3 is a perspective rear view of an exemplary sheath implement 300 for a locking system that may secure a backrest in place on a motorcycle, in accordance with an embodiment of the present invention. In the present embodiment, sheath implement 300 may be configured to engage with a lock bracket 500, as illustrated by way of example in FIG. 5 and may incorporate a lock mechanism 400, as illustrated by way of example in FIG. 4. The lock mechanism may be engaged with sheath implement 300 at a lock hole 305 using various different means including, without limitation, threading and/or adhesive. Optionally a set screw 310 with or without a thread locking substance applied to threads may be threaded into a threaded hole 315 to further secure the lock mechanism 400 in place. A sheath guide 320 near the bottom center of sheath 300 may comprise angled walls 325 that may engage with a guide block on the lock bracket 500 also comprising edges of substantially the same angle, for example, without limitation, 45 degrees. A header 330 of sheath guide 320 may act as a stopper to typically ensure that a lock cam slot 340 in sheath 300 aligns with a lock cam slot in the lock bracket 500. A spring clearance opening 345 may be provided through the length of sheath 300. The top surface of sheath 300 may comprise rounded corners 350 and overhanging edges 355 that may typically enable sheath 300 to fit within the constraints of the backrest struts and the mount. Those skilled in the art will readily recognize, in light of and in accordance with the teachings of the present invention, that sheaths in alternate embodiments may comprise a multiplicity of suitable configurations. For example, without limitation, the various openings may be sized and shaped differently, the sheath guide and the cam slot may be on opposing sides rather than the same side, and/or the location of the lock may vary. One embodiment may be implemented as a single plate of metal bent into a substantially U-shaped piece without sides. The short portion of the U that may form the top of the piece may be wider than the longer portions forming the front and back to form overhanging edges similar to overhanging edges 355. In other embodiments, the sheath implement may be dome shaped to accommodate a lock with an internal plug and carrier. In such embodiments, the sheath implement may be used as the outer shell or casing of the lock. Yet other embodiments may comprise a sheath implement and bracket designed to use a slam style lock.

FIG. 4 is an exploded side view of an exemplary lock mechanism 400 that may be incorporated into a sheath from a motorcycle backrest locking system, in accordance with an embodiment of the present invention. In the present embodiment, the lock mechanism 400 is a typical cam lock comprising a threaded lock assembly 405 and a cam 410 fastened to lock assembly 405 by a lock screw 415 with or without the application of a thread locking substance. A tubular key 420 may be used to operate the lock mechanism 400 by rotating cam 410. Alternately a flat key or combination mechanism may be used to operate the lock mechanism 400. In the present embodiment, the lock mechanism 400 may be configured so that key 420 may only be removed from lock assembly 405 when cam 410 is in a locked position. It is contemplated that alternate embodiments may incorporated different types of locks such as, but not limited to, deadbolt type locks or slam locks.

FIG. 5 is a perspective side view of a lock bracket implement 500 for a locking system that may secure a backrest in place on a motorcycle, in accordance with an embodiment of the present invention. In the present embodiment, lock bracket 500 may be a substantially rectangular plate comprising a guide block 505 and a lock cam slot 510. Guide block 505 may comprise angled edges 515 that may engage with angled walls 325 of sheath guide 320 on sheath 300 as illustrated by way of example in FIG. 3. When sliding sheath guide 320 of sheath 300 onto guide block 505, a top ledge 520 of guide block 505 may act as a stop when header 330 of sheath guide 320 makes contact. At this point lock cam slots 340 and 510 may be in alignment to typically enable cam 410 of the lock mechanism 400, illustrated by way of example in FIG. 4, to be rotated into lock cam slots 340 and 510. Optionally, the opening of lock cam slot 510 may comprise angled corners 525 to aid in guiding cam 410 into lock cam slot 510. In the present embodiment, a screw 530 may be threaded into a countersunk upper hole 535 in guide block 505 so that the head of screw 530 may be substantially flush with the surface of guide block 505. A lower screw 540 may be inserted into a lower hole 545. Screws 530 and 540 along with nylon lock nuts 550 may be used to engage lock bracket 500 with a backrest mount. It is contemplated that alternate means of engaging the lock bracket with a backrest mount may be used in some embodiments such as, but not limited to metal nuts, different types of screws, bolts, pins, welding, adhesive, or metal clips. Moreover, in some alternate embodiments the guide block may be formed into the lock bracket or attached to the lock bracket using means other than a threaded connection including, without limitation, welding or adhesive. In such embodiments, a separate upper hole to accommodate means for engagement with a backrest mount may be included above the guide block or between the guide block and the lower hole. Yet other alternate embodiments may comprise only one hole or more than two holes for the engagement means. In the present embodiment, a top edge 555 may be angled to 60 degrees to typically enable lock bracket 500 to conform to the contours of a typical backrest mount. Alternate embodiments for use with backrest mounts of various different shapes and sizes may be implemented without an angled top edge or with a top edge angled at a steeper or more shallow angle.

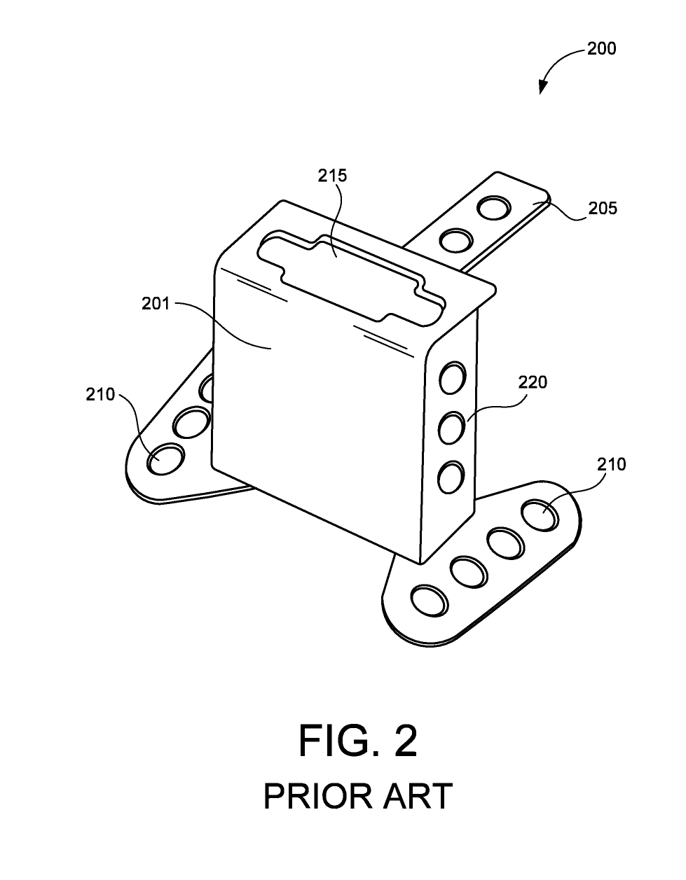

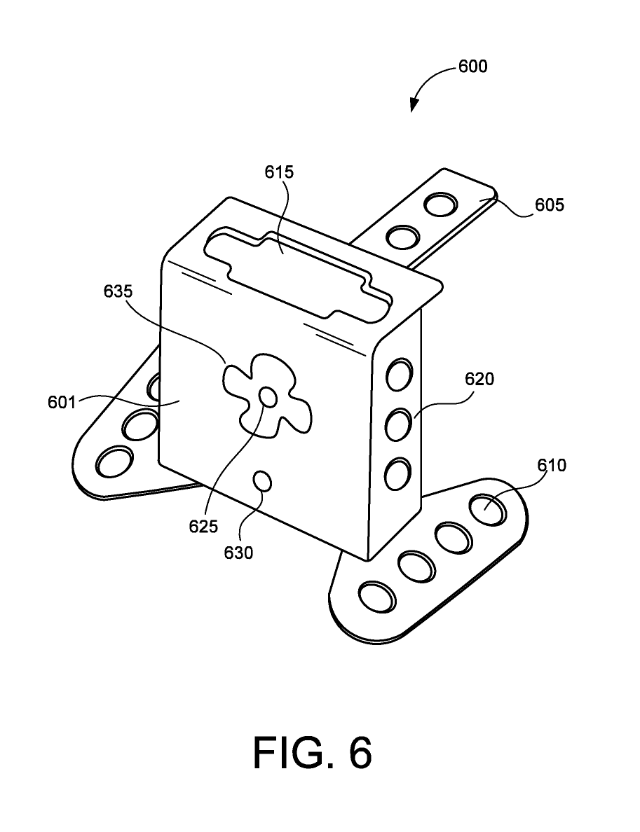

FIG. 6 is a perspective rear view of an exemplary backrest mount 600 modified for use with a locking system that may secure a backrest in place on a motorcycle, in accordance with an embodiment of the present invention. Similarly to mount 200 illustrated by way of example in FIG. 2, mount 600 may comprise a curved base plate 601, a front frame mount bracket 605, two fender mount brackets 610, a top opening 615, and anchor holes 620. It is contemplated that various means of engaging the lock bracket with the backrest mount may be used in some embodiments, such as, but not limited to nuts, screws, bolts, pins, welding, adhesive, or metal clips. In the present embodiment, to connect lock bracket 500 to backrest mount 600, a user may typically create an upper hole 625 and a lower hole 630 in base plate 601 into which screws 530 and 540 may be inserted and secured by nuts 550. In some applications a template may be provided to aid in correctly placing upper hole 625 and lower hole 630. In such applications this template may be configured to be aligned with a logo stamping 635 or other type of marking on base plate 601.

Once upper hole 625 and lower hole 630 are created, the user may insert, screw 530 into upper hole 535 of lock bracket 500. Screw 530 may be tightened with a torque wrench with the use of an adhesive. Then lock bracket 500 may be placed into opening 615 of mount 600 with screw 530 inserted into upper hole 625 of mount 600 so that lock bracket 500 may be substantially centered within opening 615. A lock nut 550 may then be placed on screw 530. Lock bracket 500 may typically be located within mount 600 with angled top edge 555 located near the curved portion of base plate 601 near opening 615. The angle of top edge 555 may typically allow for suitable clearance to accommodate the curve of base plate 601. Screw 540 may then be inserted through lower hole 630 of mount 600 and lower hole 545 of lock bracket 500 and secured with a lock nut 550. Installation of lock bracket 500 may be finished by checking the alignment of guide block 505 and sheath guide 320 when sheath 300 is inserted into opening 615 of mount 600. Once suitable alignment is achieved, both lock nuts 550 may be tightened. Optionally a thread locking substance may be used on screws 530 and 540 and nuts 550. As stated in the foregoing, it is contemplated that alternate means of engaging the lock bracket to the mount may be used in some embodiments.

An exemplary method for locking a backrest to mount 600 with installed lock bracket 500 in accordance with the present embodiment follows. After mount 600 is installed on a motorcycle and a backrest is mounted within mount 600, sheath 300 may be slid down between the backrest struts and onto lock bracket 500. The struts may help center and guide sheath onto lock bracket 500. Optionally, key 420 may be used to place sheath 300 onto lock bracket 500. Sheath guide 320 may be aligned with guide block 505 of lock bracket 500 and slid downward engaging angled edges 515 of guide block 505 with angled walls 325 of sheath guide 320 until sheath guide 320 header 330 contacts guide block 505 ledge 520 come into contact. This typically allows both lock cam slots 340 and 510 to align so when key 420 is turned cam 410 typically slides into lock cam slots 340 and 510 and into a locked position. At this time, key 420 may be removed from the lock if desired. The engagement of the 45 degree angles of guide block 505 and sheath guide 320 typically hold sheath 300 and lock bracket 500 together tightly, substantially inhibiting vibrations from interfering with the locking system which may be inherent with the motorcycle running. When in a locked position, cam 410 typically holds sheath 300 and lock bracket 500 together and substantially inhibits sheath 300 from being removed from mount 600. The top surface of sheath 300 may be flush with the top surface of mount 600 to substantially inhibit tampering with the locking system. Furthermore, curved radius corners 350 of the top surface of sheath 300 typically allows for a proper fit within opening 615 of mount 600.

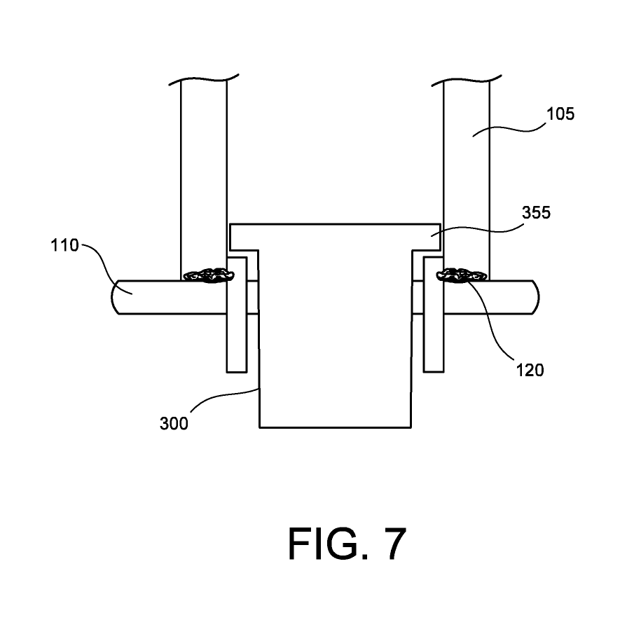

FIG. 7 is a diagrammatic front view of an exemplary sheath 300 in a locked position on a motorcycle backrest, in accordance with an embodiment of the present invention. What is shown would typically be inside a backrest mount; however, a mount is not shown for illustrative purposes. After the backrest is mounted within a mount with anchor pins 110 at the ends of struts 105 engaged with anchor holes of the mount, sheath 300 may be slid onto lock bracket 500 installed on the mount so that spring clearance openings 345 of sheath 300 may go around a spring connecting struts 105 near anchor pins 110. In typical use of the present embodiment, the width of the top surface of sheath 300, including overhanging edges 355, substantially inhibits struts 105 from being compressed for backrest removal. The recessed sides of sheath 300 under overhanging edges 355 may allow clearance for welds 120 and may substantially inhibit interference with sheath guide 320 header 330 fully engaging with guide block 505 ledge 520 of lock bracket 500.

Those skilled in the art will readily recognize, in light of and in accordance with the teachings of the present invention, that means other than a sheath guide and guide block with angled edges may be used to connect the sheath to the lock bracket in some alternate embodiments such as, but not limited to, a slider in a channel or slot, spring loaded pins, keyhole openings, screws, bolts, or a T-slot if a slam lock is used. Additionally, in the embodiments described in the foregoing, the elements of the locking system may be configured to accommodate the variable dimensions encountered with some Harley Davidson® backrests and backrest mounts. It is contemplated that alternate embodiments may be configured for use with a multiplicity of suitable brands and makes of backrests and backrest mounts. Furthermore, some embodiments may comprise a variety of additional or alternate features including, without limitation, a tether to secure the key to the sheath, alarms to alert users of attempted tampering, and carrying cases or pouches for storing the locking system when not in use.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a locking system that may secure a backrest in place on a vehicle according to the present invention will be apparent to those skilled in the art. Various aspects of the invention have been described above by way of illustration, and the specific embodiments disclosed are not intended to limit the invention to the particular forms disclosed. The particular implementation of the locking system may vary depending upon the particular context or application. By way of example, and not limitation, the locking systems described in the foregoing were principally directed to implementations for locking accessories to motorcycles; however, similar techniques may instead be applied to locking accessories to other types of vehicles such as, but not limited to, bicycles, scooters, all-terrain vehicles, and convertibles, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a sheath implement, in which said sheath implement comprises:
a sheath implement guide, in which said sheath implement guide includes a plurality of angled wall portions;
a header portion of said sheath implement guide, wherein said header portion is configured as a stopper; and
a first lock cam slot;
a lock bracket implement, wherein said lock bracket implement is configured to engage with said sheath implement, in which said lock bracket implement comprises:
a guide block section having a plurality of angled edge portions, wherein said plurality of angled edge portions are configured to engage said plurality of angled wall portions of said sheath implement guide;
a top ledge portion of said guide block section, wherein said top ledge portion is configured to engage said header portion, and wherein said top ledge portion and said header portion act as a stopper when said top ledge portion and said header portion makes contact; and
a second lock cam slot, wherein said second lock cam slot is configured to align with said first lock cam slot of said sheath implement to accept a lock mechanism; and
wherein said top ledge portion and said header portion is further configured to ensure that said first lock cam slot aligns with said second lock cam slot when said top ledge portion and said header portion makes contact.

2. The system of claim 1, wherein said sheath implement and lock bracket implement are configured to secure a backrest device in place on a backrest mount.

3. The system of claim 2, in which said lock bracket implement engages a portion of a curved base plate of the backrest mount.

4. The system of claim 3, in which said lock bracket further comprises an angled top edge that is configured to generally conform to said curved base plate of the backrest mount.

5. The system of claim 3, in which said sheath implement further comprises at least a lock hole portion that is configured to engage with said lock mechanism.

6. The system of claim 5, in which said lock mechanism comprises:
a lock assembly, in which said lock assembly is a threaded lock assembly;
a lock screw;
a cam portion, wherein said cam portion is fastened to said lock assembly by said lock screw; and
a tubular key implement, in which said tubular key implement is configured to operate said lock mechanism by rotating said cam portion.

7. The system of claim 6, in which said lock mechanism is configured to only be removed from said lock assembly when said cam portion is in a locked position.

8. The system of claim 7, wherein an alignment of said first and second lock cam slot enables said cam portion to be rotated into said first and second lock cam slot.

9. The system of claim 3, wherein said lock bracket implement engages with said curved base plate of said backrest mount with a screw secured by a lock nut.

10. The system of claim 3, in which said curved base plate of the backrest mount comprises an upper and lower hole corresponding to an upper and lower hole of said lock bracket.

11. The system of claim 2, in which said backrest device comprises:
an anchor pin part, wherein said anchor pin part is connected to a strut piece, in which said anchor pin part comprises a pair of anchor pin part and in which said strut piece comprises a pair of strut pieces; and
a spring implement disposed between said pair of strut pieces, wherein said spring implement is configured to push said pair of anchor pin part away from each other.

12. The system of claim 11, in which said backrest mount comprises:
a top opening section, wherein said top opening section is operable for accepting said anchor pin part and portions of said strut piece; and
an anchor hole portion, in which said anchor hole portion is configured to engage a portion of said anchor pin, in which said anchor hole portion comprises a plurality of anchor hole portions that are configured to enable said anchor pin part to be adjust to different heights.

13. A system comprising:
means for engaging a lock bracket on a curved base plate of a backrest mount;
means for engaging a sheath implement to said lock bracket;
means for locking said lock bracket and sheath implement to said backrest mount;
means for engaging said locking means;
means for operating said locking means;
a plurality of angled wall portions;
a first lock cam slot;
means for engaging said plurality of angled wall portions;
means for engaging a header portion, wherein said header portion engaging means and said header portion act as a stopper when said header portion engaging means and said header portion makes contact;
means for engaging said first lock cam slot, wherein said first lock cam slot engaging means is configured to align with said first lock cam slot to accept said lock means; and
wherein said header portion engaging means and said header portion is further configured to ensure that said first lock cam slot aligns with said first lock cam slot engaging means when said header portion engaging means and said header portion makes contact.

14. The system of claim 13, further comprising means for operating said lock mechanism, wherein said lock mechanism is configured to only be removed from said lock engaging means when said locking means is in a locked position.

15. A system comprising:
a sheath implement, wherein said sheath implement is configured to engage with a lock bracket implement, in which said sheath implement comprises:
a sheath implement guide, in which said sheath implement guide includes a plurality of angled wall portions;
a header portion of said sheath implement guide, wherein said header portion is configured as a stopper; and
a first lock cam slot portion;
a lock bracket implement, in which said lock bracket implement comprises:
a guide block section having a plurality of angled edge portions, wherein said plurality of angled edge portions are configured to engage said plurality of angled wall portions of said sheath implement guide;
a top ledge portion of said guide block section, wherein said top ledge portion is configured to engage said header portion, and wherein said top ledge portion and said header portion act as a stopper when said top ledge portion and said header portion makes contact; and
a second lock cam slot portion, wherein said second lock cam slot portion is configured to align with said first lock cam slot portion of said sheath implement to accept a lock mechanism; and
wherein said first lock cam slot portion aligns with said second lock cam slot portion when said top ledge portion and said header portion makes contact.

16. The system of claim 15, wherein said sheath implement and said lock bracket implement are configured to secure a backrest device in place on a backrest mount attached to a motorcycle.

17. The system of claim 16, wherein said lock bracket implement engages a portion of a curved base plate of the backrest mount, in which said lock bracket further comprises an angled top edge that is configured to generally conform to said curved base plate of the backrest mount.

18. The system of claim 17, in which said lock mechanism comprises:
a lock assembly, in which said lock assembly is a threaded lock assembly;
a lock screw;
a cam portion, wherein said cam portion is fastened to said lock assembly by said lock screw; and
a tubular key implement, in which said tubular key implement is configured to operate said lock mechanism by rotating said cam portion.

19. The system of claim 18, in which said sheath implement further comprises at least a lock hole portion that is configured to engage with said lock mechanism;
in which said lock mechanism is configured to only be removed from said lock assembly when said cam portion is in a locked position; and
wherein an alignment of said first and second lock cam slot portions enables said cam portion to be rotated into said first and second lock cam slot portions.

20. The system of claim 16, in which said curved base plate of the backrest mount comprises an upper and lower hole corresponding to an upper and lower hole of said lock bracket, wherein said lock bracket implement engages with said curved base plate of said backrest mount with a screw secured by a lock nut.
